(19) United States
(12) Patent Application Publication
(10) Pub. No.: US 2018/0274951 A1
(43) Pub. Date: Sep. 27, 2018

(54) OUTPUT SWITCHING SYSTEMS AND METHODS

(71) Applicant: Infineon Technologies AG, Neubiberg (DE)

(72) Inventors: Tobias Werth, Villach (AT); Cosmin Filip, Bucharest (RO); Catalina-Petruta Juglan, Botosani (RO)

(73) Assignee: Infineon Technologies AG, Neubiberg (DE)

(21) Appl. No.: 15/467,439

(22) Filed: Mar. 23, 2017

(51) Int. Cl. G01D 5/248

(52) U.S. Cl. CPC G01D 5/248

(57) ABSTRACT

Switching threshold determination systems and methods for sensors are described. Individual rising and/or falling edge maxima of a target can be determined. Based on the maxima, individual rising and/or falling edge thresholds can be determined. The individual rising and falling edge thresholds can be used to detect one or more target of the target wheel.

### BACKGROUND

### Field

Embodiments described herein generally relate to sensors and more particularly to output switching systems and methods for magnetic sensors.

### Relater Art

Magnetic field sensors have many applications, one of which is automobile engine management applications. For example, magnetic field sensors associated with rotating tooth or pole wheels and a back bias magnet can be used to sense rotation and/or positioning of the camshaft.

Accurate engine control can be used to reduce engine emissions. This can be provided using one or more sensors, such as those which provide improved output switching and are less dependent on the relative positioning of the sensor and the rotating element, as the sensor signal depends on both the strength of the magnetic field and the distance between the sensor and the target element.

Conventional solutions for determining output switching thresholds typically are reactive, based on a slow regulation as a reaction to current signal characteristics. One of two approaches generally is taken: to set a single threshold over the entire pattern with slow adaptation after an overall pattern change (slow reactive algorithm); or to continuously adapt according to the last pair of a signal maximum and a signal minimum (fast reactive algorithm. However, these approaches provide sub-optimal phase accuracy.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 illustrates a system includes a target wheel and a sensor system according to an exemplary embodiment of the present disclosure.

FIG. 2 illustrates a sensor system according to an exemplary embodiment of the present disclosure.

FIG. 3 illustrates a sensor system according to an exemplary embodiment of the present disclosure.

FIG. 4 illustrates a sensor system according to an exemplary embodiment of the present disclosure.

FIG. 5 illustrates a sensor system according to an exemplary embodiment of the present disclosure.

FIG. 6 illustrates a signal diagram of a sensor system according to an exemplary embodiment of the present disclosure.

FIG. 7 illustrates a signal diagram of a sensor system according to an exemplary embodiment of the present disclosure.

FIG. 8 illustrates a flowchart of an individual edge maxima determination method according to an exemplary embodiment of the present disclosure.

FIG. 9 illustrates a flowchart of a target determination method according to an exemplary embodiment of the present disclosure.

The exemplary embodiments of the present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure.

As an overview, embodiments relate to predictive output switching threshold determination systems and methods for sensors, for example magnetic field sensors. In one or more exemplary embodiments, at least one individual switching threshold is determined predictively, rather than reactively, for each tooth or pole of a ferromagnetic tooth or pole wheel, respectively. For example, a rising-edge individual switching threshold corresponding to a rising edge of one or more teeth or poles and/or a falling-edge individual switching threshold for a corresponding falling edge of the one or more teeth or poles can be determined. In one or more exemplary embodiments, a rising-edge maxima for the rising edge and/or a falling-edge maxima for the falling edge can be determined, and the rising-edge individual switching threshold and/or falling-edge individual switching threshold can be determined based on the rising edge and the falling-edge maxima, respectively.

In an exemplary aspect, the tooth or pole can be detected based the rising-edge individual switching threshold and/or falling-edge individual switching threshold in a first mode of operation and based on a common switching threshold in a second mode of operation. For example, the mode of operation can be based on a frequency of the target wheel, and the particular threshold can be selected based on the frequency of the target wheel. In an exemplary embodiment, if the frequency of the target wheel is below a frequency threshold (e.g., the target wheel is rotating at a low rotation per minute (RPM)), the detection of the tooth can be based on the common switching threshold. If the frequency of the target wheel is equal to or above a frequency threshold (e.g., the target wheel is rotating at high RPM such as at an idle or higher RPM), the detection of the tooth can be based on the individual switching threshold and/or falling-edge individual switching threshold.

Embodiments can compensate for phase error caused by eccentrically-mounted target wheels (i.e., wobble of a tooth or pole wheel not centered on an axis). To improve the compensation of phase error, individual switching thresholds per tooth of a target wheel can be used. The compensation can be further improved using rising and/or falling individual thresholds per tooth.

Embodiments can also compensate for backwards movement of the target wheel such as when the motor is stopped. For example, the individual switching threshold may assume a continuous forward movement of the target wheel in predicting the individual switching threshold based on the number of target wheel teeth. At the motor stop, the target wheel may rotate backwards (e.g., at least by 40°) and therefore the predicted next switching threshold may be inaccurate without a compensation for this backward movement. Further, the backward-forward movement may generate inaccurate extrema information for an individual switching threshold calculation.

In an exemplary operation, the number of teeth or poles can be programmed, and an optimal threshold for each tooth or pole is determined during a rotation of the wheel. The determined optimal threshold for each tooth is then used for that tooth in at least one subsequent rotation of the wheel, with calibration optionally taking place in future subsequent rotations. Thus, in embodiments, thresholds are predictive for each individual tooth or pole rather than reactive to an adjacent tooth or pole.

Embodiments thereby can provide improved phase accuracy while also better calibrating and/or compensating for run-out, manufacturing and positioning tolerances between the sensor and the target wheel. These and other embodiments also provide additional benefits and advantages as discussed herein.

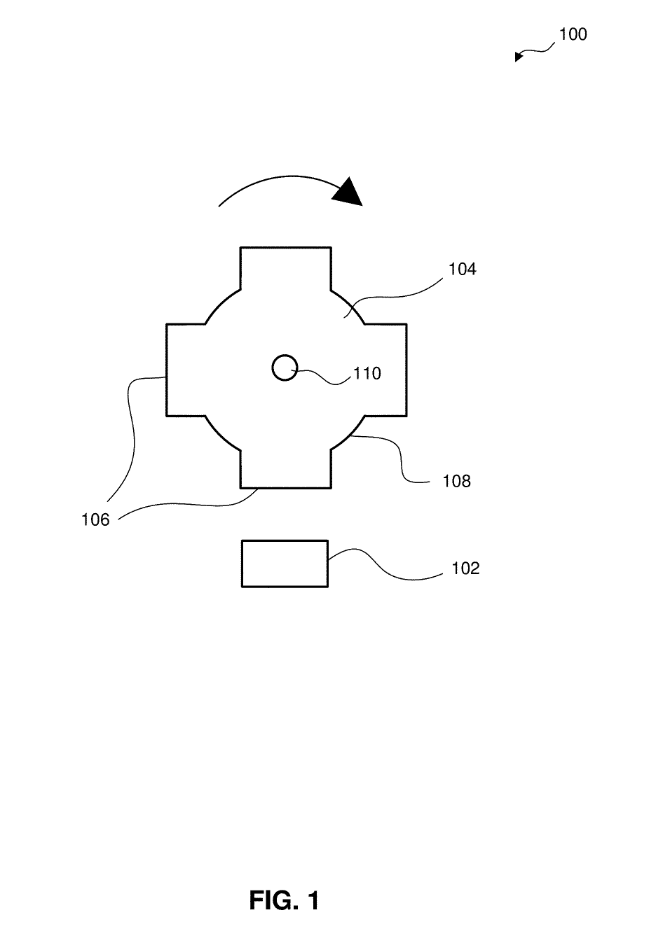

FIG. 1 illustrates a system 100 according to an exemplary embodiment of the present disclosure. The system 100 can include a sensor system 102 spaced apart from a target wheel 104. In an exemplary embodiment, the sensor system 102 includes a magnetic field sensor, such as a Hall-effect sensor, though sensor system 102 can include other sensor types in one or more embodiments as would be understood by one of ordinary skill in the relevant arts. In an exemplary embodiment, the sensor system 102 also includes signal processing circuitry, such as sensor circuitry.

In embodiments in which sensor system 102 comprises a magnetic field sensor, target wheel 104 is ferromagnetic and includes a tooth wheel (as shown in FIG. 1), a pole wheel or some other suitable target device as would be understood by one of ordinary skill in the art.

The sensor system 100 can also include a back bias magnet (not illustrated). In embodiments in which some other type of sensor 102 is used (the target wheel includes some other suitable target), rotation or movement of which can be detected by sensor system 102.

In an exemplary embodiment, the target wheel 104 includes four teeth 106, but this number can be higher or lower in other embodiments. For convenience, a four-tooth wheel as depicted in FIG. 1 will be used herein throughout as an example target wheel 104 but is in no way to be considered limiting with respect to other embodiments.

Each tooth 106 of target wheel 104 is depicted for convenience in FIG. 1 as being approximately equal in size (i.e., having about the same width and same height relative to the valleys 108 or remainder of target wheel 104). In one or more exemplary embodiments, the teeth 106 can vary from one another intentionally and/or unintentionally. For example, teeth 106 can vary from one another intentionally such that sensor system 100 can more easily determine exactly where the target wheel 104 is in the rotation. Teeth 106 also can vary from one another unintentionally, for example because of manufacturing tolerances or defects.

In an exemplary embodiment, the target wheel 104 can include two teeth 106 of a larger size and two teeth 106 of a smaller size. For example, two large teeth 106 can have a width corresponding to, for example, 70° and two smaller teeth 106 having a width corresponding to, for example, 20°. Embodiments are not limited to these example sizes and the teeth 106 can have other sizes as would be understood to one of ordinary skill in the relevant arts.

In one or more exemplary embodiments, the number of teeth or poles of the target wheel 104 can be programmed into memory (e.g., EEPROM) of sensor system 102 and/or an external memory; and/or the sensor system 102 can be configured to detect or otherwise determine the number of teeth.

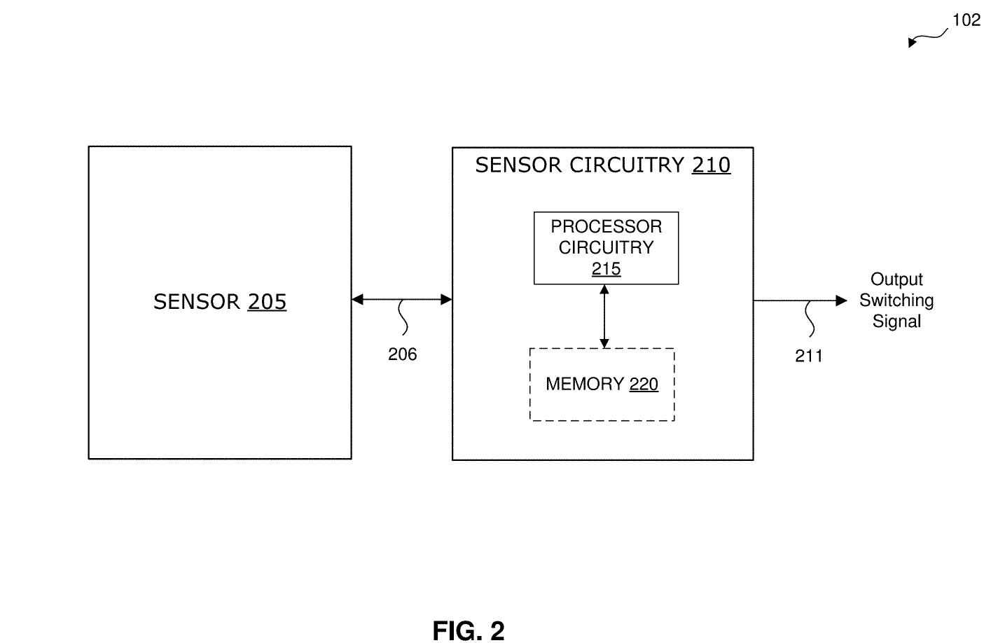

With reference to FIG. 2, in an exemplary embodiment of the present disclosure, the sensor system 102 includes a sensor 205 communicatively coupled to sensor circuitry 210 via communication path 206.

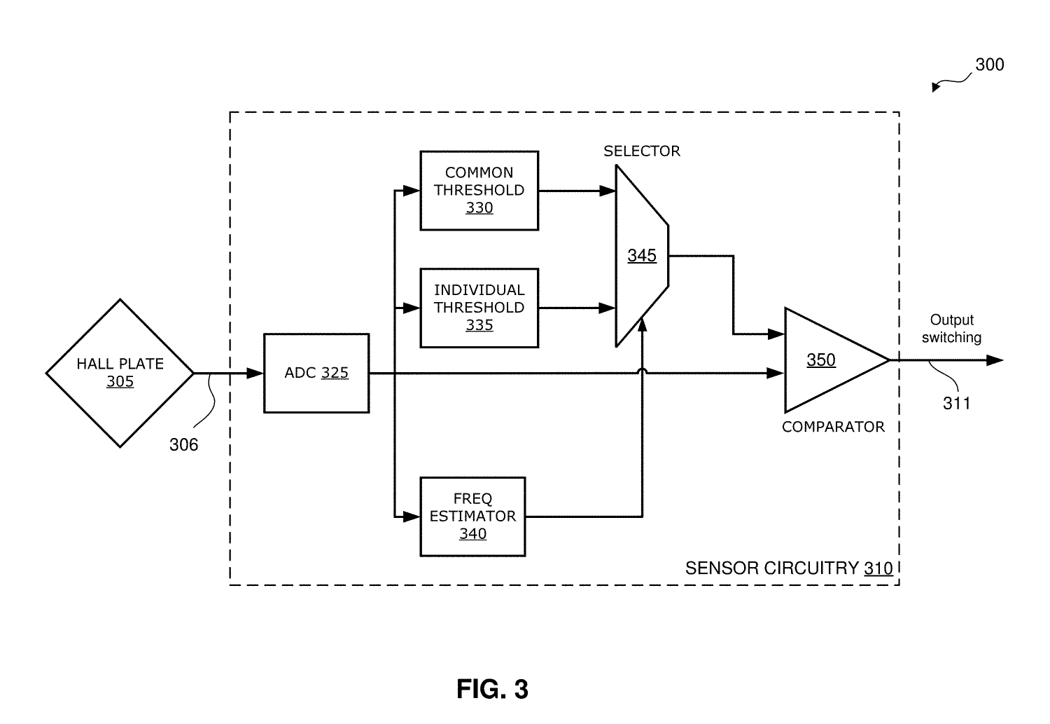

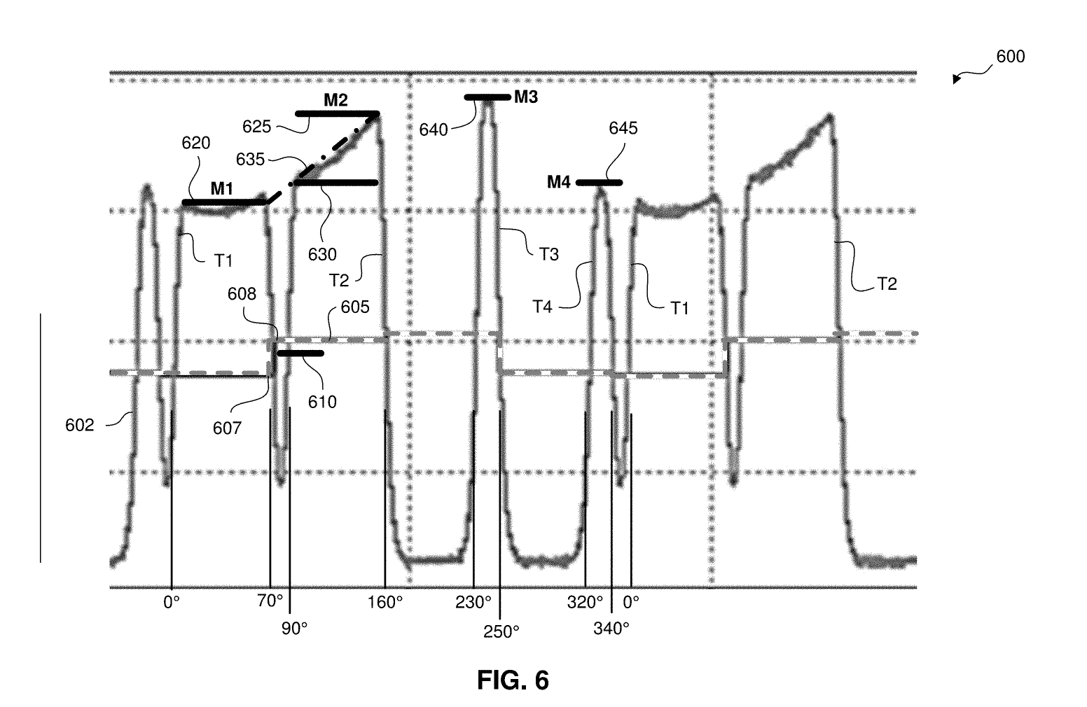

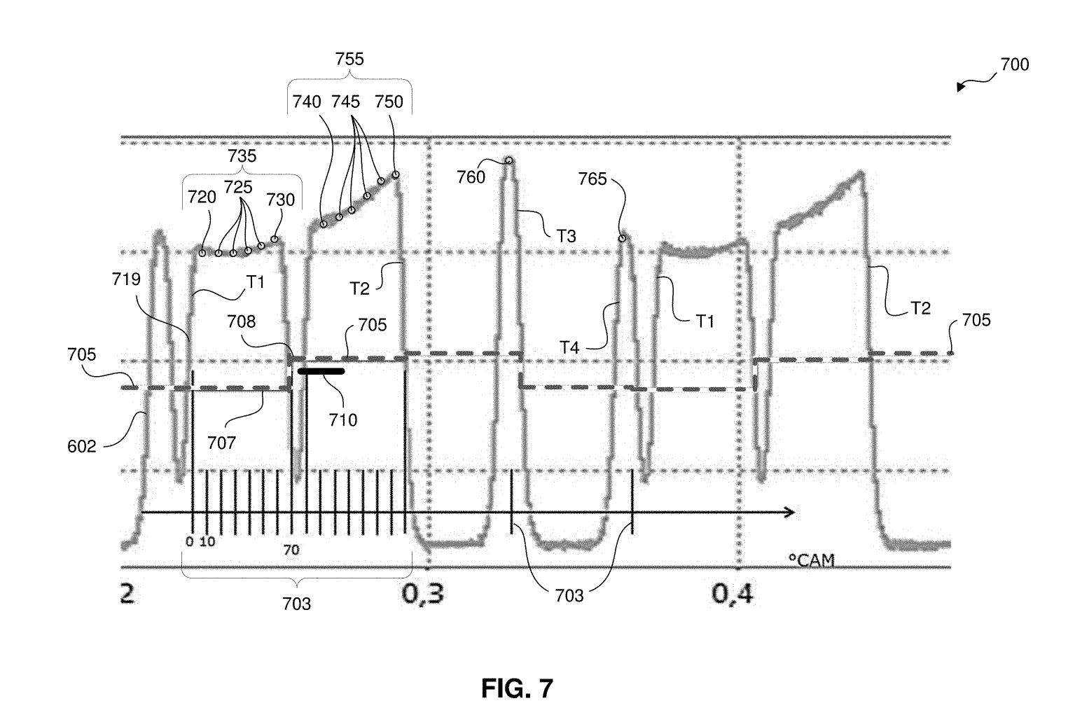

The sensor 205 can be a magnetic field sensor, such as a Hall-effect sensor, but is not limited thereto. The sensor 205 can be another sensor type as would be understood by one of ordinary skill in the relevant arts. The sensor 205 can be configured to sense or otherwise detect a varying magnetic field caused by the rotating target wheel 104, and generate a magnetic field signal (e.g., signal 306 in FIG. 3, signal 602 in FIGS. 6 & 7) based on a sensed magnetic field. As illustrated in, for example, FIGS. 6 and 7, the signal 602 can include peaks and valleys corresponding to the teeth 106 and valleys 108 of the target wheel 104. Signal 602 indicates differences between the four teeth (not depicted in FIG. 1) such that the relative maximum strength and phase of the magnetic field varies during rotation. The minimum strength is relatively constant, though this also can vary in other embodiments. System 100 therefore switches from high to low, or on to off, as target wheel 104 rotates and the magnetic field detected by sensor system 102 varies from high to low.

The sensor circuitry 210 is signal processing circuitry that is configured process the magnetic field signal received from the sensor 205 and generate an output switching signal 211 based on the processed magnetic field signal. In an exemplary embodiment, the sensor circuitry 210 includes processor circuitry 215 configured to process the magnetic field signal received from the sensor 205 and generate an output switching signal 211 based on the processed magnetic field signal. The sensor circuitry 210 can also include a memory 220 that is communicatively coupled to the processor circuitry 215. The memory 220 can store data and/or instructions, where when the instructions are executed by the processor circuitry 215, controls the processor circuitry 215 to perform the functions described herein. The memory 220 can store, for example, the number of targets, one or more switching thresholds, one or more maxima values, one or more minima values, and/or other information as would be understood by one of ordinary skill in the relevant arts. The memory 220 can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory 220 can be non-removable, removable, or a combination of both.

The processor circuitry 215 can be configured to control the overall operation of the sensor system 102, such as the operation of the sensor circuitry 210 and/or the sensor 205. The processor circuitry 215 can be configured to run one or more applications, operating systems, power management functions (e.g., battery control and monitoring), and/or other operations as would be understood by one of ordinary skill in the relevant arts.

FIG. 3 illustrates a sensor system 300 according to an exemplary embodiment of the present disclosure. The sensor system 300 includes a sensor 305 communicatively coupled to sensor circuitry 310. The sensor 305 can be an exemplary embodiment of the sensor 205. Similarly, the sensor circuitry 310 can be an exemplary embodiment of the sensor circuitry 210.

The sensor 305 is a magnetic field sensor, such as a Hall-effect sensor, but is not limited thereto. The sensor 305 can be configured to sense or otherwise detect a varying magnetic field caused by the rotating target wheel 104, and generate a magnetic field signal 306 based on a sensed magnetic field. The magnetic field signal 306 is then provided to the sensor circuitry 210.

In an exemplary embodiment, the sensor circuitry 310 includes an analog-to-digital converter (ADC) 325, common threshold circuit 330, individual threshold circuit 335, frequency estimator 340, selector 345, and comparator 350.

The ADC 325 is configured to convert an analog signal to a digital signal representing the analog signal. For example, the ADC 325 can be configured to generate a digital magnetic field signal based on the analog magnetic field signal 306 received from the sensor 305. The ADC 325 provides the digital magnetic field signal to the common threshold circuit 330, the individual threshold circuit 335, the frequency estimator 340, and/or comparator 350. In an exemplary embodiment, the ADC 325 can include processor circuitry configured to convert an analog signal to a digital signal.

In an exemplary embodiment, the ADC 325 is configured to output both a digital representation of the analog magnetic field signal 306 and provide the analog magnetic field signal 306 and the digitally converted magnetic field signal 306 to the components of the sensor circuitry 310. In this example, one or more of the components of the sensor circuitry 310 is configured to process analog signals, including the analog magnetic field signal 306, while one or more other components of the sensor circuitry 310 is configured to process digital signals such as the digitally converted magnetic field signal 306.

In an exemplary embodiment, the ADC 325 can be included in the sensor 305 and the sensor 305 is configured to output the digital magnetic field signal 306 to the sensor circuitry 310. In an alternative embodiment, the ADC 325 is omitted and the components of the sensor circuitry 310 are configured to process analog signals, including the analog magnetic field signal 306.

The common threshold circuit 330 is configured to determine or calculate one or more common switching thresholds based on the magnetic field signal from the ADC 325. The common switching threshold(s) are then provided to the selector 345. In an exemplary embodiment, the common threshold circuit 330 includes processor circuitry that is configured to determine or calculate one or more common switching thresholds based on the magnetic field signal.

The common switching threshold(s) correspond to a switching threshold for two or more targets 106 of the target wheel 104. For example, the common switching threshold is a switching threshold that is associated with all of the targets 106. In this example, the common switching threshold is used to generate an output switching signal 311 that is applied for each of the targets 106 of the target wheel. That is, common threshold circuit 330 can determine a single common switching threshold for first, second, third, and fourth targets (teeth) 106.

In an exemplary embodiment, the common threshold circuit 330 is configured to generate an average switching threshold based on two or more of the targets 106. For example, the common switching threshold is an average of the individual thresholds of the corresponding targets 106 of the target wheel 104.

The individual threshold circuit 335 is configured to determine or calculate one or more individual switching thresholds based on the magnetic field signal from the ADC 325. The individual switching threshold(s) are then provided to the selector 345. In an exemplary embodiment, the individual threshold circuit 330 includes processor circuitry that is configured to determine or calculate one or more individual switching thresholds based on the magnetic field signal.

In these embodiments, each individual switching threshold is associated with a single tooth 106 of the target wheel 104. For example, the individual threshold circuit 335 can determine first, second, third and fourth individual switching thresholds for first, second, third, and fourth teeth 106, respectively. In this example, respective individual switching thresholds are used to generate an output switching signal 311 for each of the corresponding teeth 106. An example individual switching threshold is illustrated by the thresholds 605, 705 in FIGS. 6 and 7. As shown, the value of the threshold changes based on the corresponding tooth 106 (e.g., maximum value at the falling edge of the tooth). For example, the threshold has a value 607 for a first tooth T1 and a value of 608 for a second tooth T2.

Using the individual switching threshold, the sensor system 300 is configured to generate an output switching signal adapted to switch from high to low, and vice-versa, at the same point geometrically for smaller and larger teeth to improve phase accuracy.

In an exemplary embodiment, the individual threshold for a corresponding tooth can be a percentage of the amplitude of the tooth. For example, the system 300 can switch from low to high when the magnetic field reaches about 70% of the maxima of the particular tooth (e.g., K-factor (K)=0.7 of the amplitude) Likewise, the system 300 can switch from high back to low when the magnetic field falls below 70% of the maxima of the field associated with the particular tooth. When the size of the tooth varies, K also can vary from tooth to tooth as shown in FIGS. 6 and 7. The value of K is not limited to this example value and can be another value as would be understood by one of ordinary skill in the art. The value of K can be predetermined and/or dynamically adjusted by the sensor system 300 (e.g., based on temperature changes, positioning, etc.).

In one or more exemplary embodiments, the sensor circuitry 310 is configured to determine an individual threshold for each tooth 106 during at least one rotation of target wheel 104. The at least one rotation can be the first rotation of target wheel 104, a preceding rotation of target wheel 104 or a current rotation of target wheel 104, or some combination thereof. The sensor circuitry 310 can use the determined individual thresholds predictively, applying the individual thresholds for future instances of the same tooth in subsequent rotations. To account for events that can occur during operation after the individual thresholds have initially been determined (e.g., temperature changes or other events that could alter the positioning of one or both of sensor 102 and target wheel 104), individual thresholds can continue to be predictively determined in future rotations to provide calibration. In one or more embodiments, individual thresholds can be re-determined or calibrated for each rotation, or at some other interval. Alternatively, the individual thresholds can be determined once and used for an ongoing basis. Regardless of whether calibration is implemented, the determined individual switching thresholds are used predictively. That is, they are determined during a first rotation of target wheel 104 for each tooth and applied in at least one subsequent rotation for future instances of that same tooth.

The frequency estimator 340 can be configured to calculate or otherwise determine the frequency (e.g., rotation per minute (RPM)) of the target wheel 104 based on the magnetic field signal from the ADC 325. The frequency estimator 340 can generate a frequency estimation signal corresponding to the determined frequency. The frequency estimation signal can then be provided to the selector 345. In an exemplary embodiment, the frequency estimator 340 includes processor circuitry that is configured to determine or calculate the frequency of the target wheel 104 based on the magnetic field signal.

The selector 345 can be configured to receive the common switching threshold(s) output from the common threshold circuit 330 and the individual switching threshold(s) from the individual threshold circuit 335, and selectively output the common switching threshold(s) or the individual switching threshold(s) as the output of the selector 345. The output of the selector 345 is then provided to the comparator 350.

In an exemplary embodiment, the selector 345 is configured to selectively output the common switching threshold(s) or the individual switching threshold(s) as the output of the selector 345 based on the frequency estimation signal from the frequency estimator 340. For example, the selector 345 can compare the determined estimation (e.g., the value of the frequency estimation signal) to a frequency threshold value, and selectively output the common switching threshold(s) or the individual switching threshold(s) based on the comparison. In an exemplary embodiment, the selector 345 includes processor circuitry that is configured to selectively output the common switching threshold(s) or the individual switching threshold(s) based on the frequency estimation signal.

In an exemplary embodiment, if the determined frequency of the target wheel 104 is below the frequency threshold (e.g., the target wheel 104 is rotating at a low RPM), the selector 345 can output the common switching threshold. If the determined frequency of the target wheel 104 is equal to or above the frequency threshold (e.g., the target wheel is rotating at high RPM such as at an idle or higher RPM), the selector 345 can output the individual switching threshold(s).

The comparator 350 is configured to receive the magnetic field signal from the ADC 325 and the threshold (individual or common) output of the selector 345, and compare the received magnetic field signal and the threshold output from the selector 345. The comparator 350 generates the output switching signal 311 based on the comparison. For example, if the magnetic field signal is greater than or equal to the threshold output from the selector 345, the comparator 350 generates the output switching signal 311 having a high value (e.g., 1). If the magnetic field signal is less than the threshold output from the selector 345, the comparator 350 generates the output switching signal 311 having a low value (e.g., 0). In an exemplary embodiment, the comparator 350 includes processor circuitry that is configured to compare the received magnetic field signal and the threshold output from the selector 345, and generate the output switching signal 311 based on the comparison. The comparator 350 can be an operational amplifier (op-amp) in an embodiment.

In exemplary embodiments, to compensate for backwards movement of the target wheel 104 (such as when the motor is stopped) that may occur during a low RPM operation, the sensor system 300 can generate the output switching signal 311 based on the common threshold generated by the common threshold circuit 330. During higher RPM operations, the sensor system 300 can compensate for phase error (e.g., caused by eccentrically-mounted target wheels) by using individual switching thresholds from the individual threshold circuit 335 to generate the output switching signal 311. In these embodiments, the sensor system 300 can provide of the output switching signal 311 having an increased switching accuracy during both low and higher RPM operations while also compensating for phase error that may be caused by eccentrically-mounted target wheels and/or target wheels having teeth of different sizes (e.g., due to manufacturing tolerances).

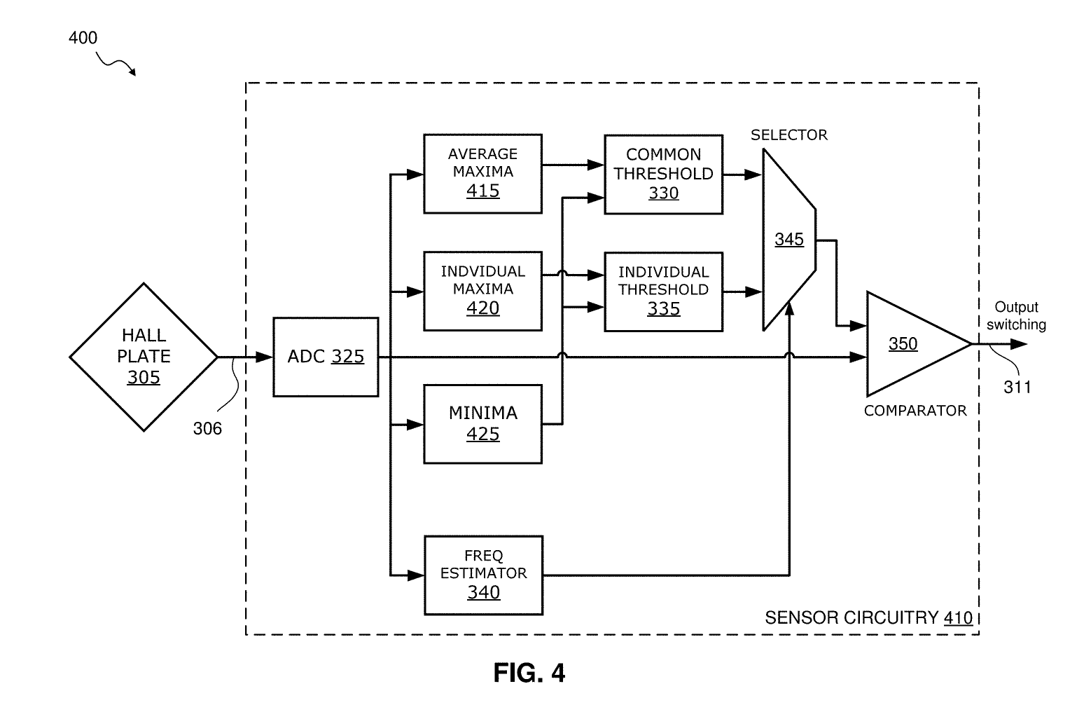

FIG. 4 illustrates a sensor system 400 according to an exemplary embodiment of the present disclosure. The sensor system 400 is similar to the sensor system 300. For example, the sensor circuitry 410 is similar to the sensor circuitry 310 but additionally includes an average maxima circuit 415, an individual maxima circuit 420, and a minima circuit 425. Discussion of common components has been omitted for brevity. In one or more exemplary embodiments as described with reference to FIG. 4, the common switching threshold(s) and the individual switching thresholds are determined based on corresponding average maxima and individual maxima, respectively.

The average maxima circuit 415 is configured to determine one or more average maximum values based on the magnetic field signal from the ADC 325. In an exemplary embodiment, the average maxima circuit 415 can determine the maximum values (e.g., maximum amplitude) of each of the teeth 106 of the target wheel 104, and calculate an average maximum value for the target wheel 104. The average maxima circuit 415 can include one or more memory units that can store the maximum values and/or the determined average maximum value(s). The average maximum values can be referred to as average maxima. In an exemplary embodiment, the average maxima circuit 415 includes processor circuitry that is configured to determine the maximum values and/or the average maximum value(s), and/or store the maximum values and/or the average maximum value(s).

The individual maxima circuit 420 is configured to determine one or more maximum values based on the magnetic field signal from the ADC 325. In an exemplary embodiment, the individual maxima circuit 420 can determine the maximum values (e.g., maximum amplitude) of each of the teeth 106 of the target wheel 104. The individual maxima circuit 420 can include one or more memory units that can store the maximum values. The maximum values can be referred to as individual maxima. In an exemplary embodiment, the individual maxima circuit 420 includes processor circuitry that is configured to determine the individual maximum values and/or store the individual maximum values.

The minima circuit 425 is configured to determine one or more average maximum values based on the magnetic field signal from the ADC 325. In an exemplary embodiment, the minima circuit 425 can determine one or more minimum values (e.g., minimum amplitude) of each of the teeth 106 of the target wheel 104, and calculate an average minimum value for the target wheel 104. The minima circuit 425 can include one or more memory units that can store the minimum values and/or the determined average minimum value(s). In an exemplary embodiment, the minima circuit 425 includes processor circuitry that is configured to determine the minimum values and/or the average minimum value(s), and/or store the minimum values and/or the average minimum value(s).

In an exemplary embodiment, the common threshold circuit 330 is configured to determine or calculate one or more common switching thresholds based on one or more average maximum values from the average maxima circuit 415 and/or one or more minimum values (or average minimum values) from the minima circuit 425.

In an exemplary embodiment, the individual threshold circuit 335 is configured to determine or calculate one or more individual switching thresholds based on one or more individual maximum values from the individual maxima circuit 420 and/or one or more minimum values (or average minimum values) from the minima circuit 425. In an exemplary embodiment, the individual maximum threshold value for a tooth 106 can be determined based on a corresponding individual maximum value for the tooth 106.

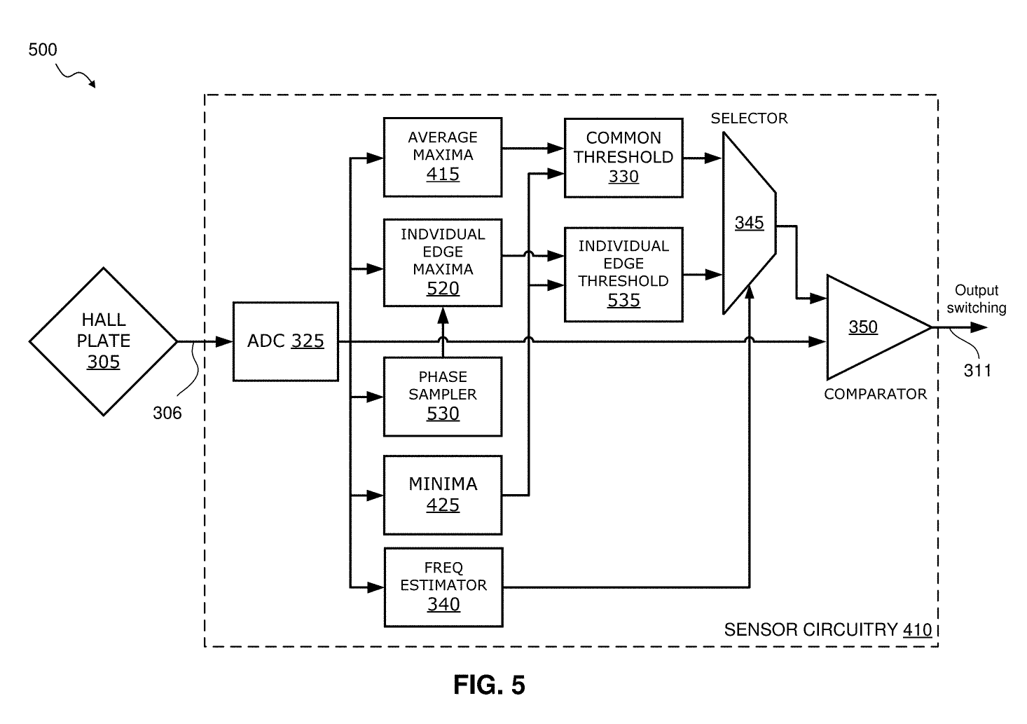

FIG. 5 illustrates a sensor system 500 according to an exemplary embodiment of the present disclosure. The sensor system 500 is similar to the sensor systems 300 and 400. For example, the sensor circuitry 510 is similar to the sensor circuitries 310 and 410 but additionally includes a phase sampler 530, and the individual maxima circuit 420 and individual threshold circuit 335 are replaced with individual edge maxima circuit 520 and individual edge threshold circuit 535, respectively. Discussion of common components has been omitted for brevity. In one or more exemplary embodiments as described with reference to FIG. 5, the common switching threshold(s) are determined based on corresponding average maxima similar to embodiments illustrated in FIG. 4 and individual edge thresholds for rising and/or falling edges of a corresponding tooth are determined based on corresponding individual edge maxima.

The phase sampler 530 is configured to determine to calculate or otherwise determine the phase of the target wheel 104 based on the magnetic field signal from the ADC 325. The phase sampler 530 can generate a sampling signal (e.g., signals 703 in FIG. 7) at a determined phase increment based on the magnetic field signal (e.g., signal 602) from the ADC 325. The sampling signal can then be provided to the individual edge maxima circuit 520. For example, the phase sampler 530 can be configured to determine the phase of the target wheel 104 and generate a sampling signal 703 at, for example, a 10° interval. In this example, the sampling signal 703 is shown as pulses at 10°, 20°, 30°, 40°, 50°, 60°, 70°, and so on of the target wheel 104. In an exemplary embodiment, the geometry (teeth width, etc.) of the target wheel 104 is known, or determined by the sensor circuitry 510 through one or more calibration operations (e.g., a first complete rotation of the target wheel 104). Based on the known geometry, the phase sampler 530 can generate the sampling signal at a set phase interval. The phase interval can be predetermined or dynamically adjusted based on one or more factors (e.g., frequency of the target wheel 104). In operation, the sampling signal can be used to identify the individual teeth 106, including particular portions of the teeth 106.

In an exemplary embodiment, the phase sampler 530 is configured to count teeth of the target wheel 104 based on the magnetic field signal from the ADC 325. For example, based on the known geometry of the target wheel 104 and the counting of teeth 106, the phase sampler 530 can identify the particular teeth T1-T4 of the target wheel 104. In this embodiment, the phase sampler 530 is referred to as tooth counter 530. In an exemplary embodiment, the tooth counter 530 can detect the particular teeth 106 using one or more other sensors such as an optical sensor. In an exemplary embodiment, the phase sampler/tooth counter 530 includes processor circuitry that is configured to generate a sampling signal at a determined phase increment based on the magnetic field signal and/or count the teeth of the target wheel.

The individual edge maxima circuit 520 is configured to determine one or more maximum values based on the magnetic field signal from the ADC 325. In an exemplary embodiment, the individual edge maxima circuit 520 can determine the maximum values (e.g., maximum amplitude) of the rising edge and/or the falling edge of each of the teeth 106 of the target wheel 104. The individual edge maxima circuit 520 can include one or more memory units that can store the maximum values corresponding to the rising and/or falling edges. The rising and falling edge maximum values can be referred to generally as individual edge maxima. In an exemplary embodiment, the individual edge maxima circuit 520 includes processor circuitry that is configured to determine the maximum values of the rising edge and/or the falling edge of each of the teeth 106, and/or store the maximum values of the rising edge and/or the falling edge of each of the teeth 106. The determination of the maxima values of the rising edge and/or the falling edge of the corresponding teeth 106 is further described with reference to FIG. 6, which illustrates the magnetic field signal 602 (e.g., from the ADC 325). The signal 602 includes peaks that correspond to teeth T1-T4 and the valleys there between.

The teeth T1-T4 have respective maximum amplitudes 620 (M1), 625 (M2), 640 (M3) and 645 (M4). In an exemplary embodiment, the maximum amplitudes 620 (M1), 625 (M2), 640 (M3) and 645 (M4) correspond to the maximum amplitudes at the respective falling edges of the teeth, but are not limited thereto. That is, the maximum amplitudes 620 (M1), 625 (M2), 640 (M3) and 645 (M4) can correspond to the maximum amplitudes at the rising edges of the teeth in one or more other embodiments.

In an exemplary embodiment, the individual edge maxima circuit 520 is configured to determine the maximum values of the falling edges of each of the teeth 106 (T1-T4). Based on the maximum values of the falling edges, the individual edge maxima circuit 520 is configured to determine the maximum values of the rising edges.

For example, with reference to FIG. 6, the individual edge maxima circuit 520 can determine the individual rising-edge maximum of the rising edge of a tooth (e.g., T2) based on the individual falling-edge maximum for the falling edge of the tooth and an individual falling-edge maximum for a falling edge of a previous tooth (e.g., T1) of the target wheel 104. In this example, the individual edge maxima circuit 520 can determine, for example, the maximum amplitude 620 (M1) of T1 at the falling edge of the tooth T1 and the maximum amplitude 625 (M2) of T2 at the falling edge of the tooth T2. Based on the maximum amplitude 620 (M1) of T1 and the maximum amplitude 625 (M2) of T2, the individual edge maxima circuit 520 can determine the maximum amplitude 630 of the rising edge of T2. In an exemplary embodiment, the individual edge maxima circuit 520 can be configured to interpolate (e.g., 635) between the maximum amplitude 620 (M1) of T1 and the maximum amplitude 625 (M2) of T2 to determine the maximum amplitude 630 at the rising edge of T2.

In an exemplary embodiment, the determination of a rising edge maximum based on two falling edge maxima can be based on a known geometry of the target wheel 104 and one or more identifications of the corresponding teeth 106 of the target wheel 104. For example, the phase sampler/tooth counter 530 can generate a signal that identifies the teeth T1-T4 and provide the signal to the individual edge maxima circuit 520 to control/instruct the individual edge maxima circuit 520 to determine the individual edge maximum.

In an exemplary embodiment, with reference to FIG. 6, the rising edge maximum of a tooth can be determined based on the following equation:

T2_{RE}=T1_{FE}+P×(T2_{FE}−T1_{FE})

Where T2_{RE} is the rising edge maximum (e.g., maximum amplitude 630) of the tooth T2, T1_{FE} is the falling edge maximum (e.g., maximum amplitude 620) of the tooth T1, T2_{FE} is the falling edge maximum (e.g., maximum amplitude 625) of the tooth T2, and P is a phase ratio of the target wheel. For example, the phase ratio P can be 20/70 (i.e., 2/7) corresponding to a 70° phase width of the tooth T2 and a 20° phase width of the valley between tooth T2 and tooth T1.

Returning to FIG. 5, in an exemplary embodiment, the individual edge threshold circuit 535 is configured to determine or calculate one or more individual edge switching thresholds based one or more rising edge maximum values and/or one or more falling edge maximum values from the individual edge maxima circuit 520 and/or one or more minimum values (or average minimum values) from the minima circuit 425.

For example, with reference to FIG. 6, the individual edge threshold circuit 535 is configured to determine an individual rising edge switching threshold 610 for the rising edge of the tooth T2 based on the rising edge maximum value (e.g., 630) determined by the individual edge maxima circuit 520. In some embodiments, this determination can also be based on one or more minimum values (or average minimum values) from the minima circuit 425.

As illustrated in FIG. 6, the individual rising edge switching threshold 610 for the tooth T2 has a value between the switching threshold for the falling edge of the tooth T1 (threshold value 607) and the switching threshold for the falling edge of the tooth T2 (threshold value 608). In this example, the individual switching thresholds for the falling edges of the respective teeth are represented by the individual switching threshold signal trace 605. By calculating both rising and falling edge switching thresholds for the particular teeth, phase error (e.g., caused by eccentrically-mounted target wheels) can be more accurately compensated. In this example, the difference in maxima between the rising and falling edges of the tooth T2 may be caused by the target wheel 104 being eccentrically mounted.

FIG. 7 illustrates an example signal diagram of the magnetic field signal 602 similar to FIG. 6. Similar to FIG. 6, the rising edge switching threshold (e.g., 710) can be determined based on based one or more rising edge maximum values and/or one or more falling edge maximum values (and/or one or more minimum values).

In an exemplary embodiment, the individual edge maxima circuit 520 is configured to determine a plurality of maximum values (e.g., 735 and 755) based on the magnetic field signal from the ADC 325. In an exemplary embodiment, the individual edge maxima circuit 520 can sample the maximum values (e.g., maximum amplitude) of a corresponding tooth based on the sampling signal from the phase sampler 530. For example, the individual edge maxima circuit 520 can sample the maximum values 735 for tooth T1 and maximum values 755 for tooth T2. In this example, the samples 735 (720 to 730) are sampled at 10° increments based on the sampling signal.

In an exemplary embodiment, the individual edge threshold circuit 535 is configured to compare two or more of the samples 735 from the individual edge maxima circuit 520 with each other to determine if one or more samples of the maximum samples 735 is a valid maximum value, or if the sample should be discarded. For example, the individual edge threshold circuit 535 can compare the sample 720 with one or more of the samples 725 (and possibly sample 730). If the difference between the sample 720 and the compared sample(s) is below or equal to a threshold value, the sample 720 is considered valid (i.e., is not an outlier sample). This sample 720 is then classified as the maximum value that corresponds to the individual rising edge maximum value of the rising edge of the tooth T1. If the difference between the sample 720 and the compared sample(s) is above the threshold, the sample 720 is discarded. For example, if the sample 720 is actually taken from a lower point on the edge of the signal (e.g., at point 719), the difference between the sample at 719 and the compared sample(s) (e.g., 725) would be large. In this case, the sample at 719 would be discarded. The next sample of the samples 735 would then be selected and compared with one or more other samples of the remaining samples 735. For example, the first sample 725 can be compared with the second through fourth samples 725 to determine if the difference between the samples is small. If so, the first sample of sample 725 would be classified as the individual rising edge maximum value of the rising edge of the tooth T1.

A similar process can be used to determine the individual falling edge maximum value of the falling edge of the tooth T1. For example, sample 730 can be compared with one or more of the samples 725 to determine if the samples are close in value

With reference to FIG. 7, the individual edge threshold circuit 535 is configured to determine an individual rising edge switching threshold 710 for the rising edge of the tooth T2 based on the rising edge maximum value (e.g., 740) based on the samples 775 determined by the individual edge maxima circuit 520. In some embodiments, this determination can also be based on one or more minimum values (or average minimum values) from the minima circuit 425.

The individual rising edge switching threshold 710 for the tooth T2 has a value between the switching threshold for the falling edge of the tooth T1 (threshold value 707) and the switching threshold for the falling edge of the tooth T2 (threshold value 708). In this example, the individual switching thresholds for the falling edges of the respective teeth are represented by the individual switching threshold signal trace 705. In this example, the sample 740 of the samples 755 is classified as the individual rising edge maximum value of the rising edge of the tooth T2 based on the process described above with respect to tooth T1. That is, the maximum rising edge maximum at sample 740 is used to calculate the individual rising edge switching threshold 710.

As illustrated in FIG. 7, the traces for teeth T3 and T4 reflect a narrower tooth of the target wheel 104. For narrower teeth, fewer samples (e.g., 1 sample) can be used to determine the switching threshold for the corresponding tooth. For example, tooth T3 has a sample 760 and tooth T4 has a sample 765. In this example, the rising and falling switching thresholds can be determined based on the single sample for the tooth and can correspond to a single individual switching threshold for the tooth.

By calculating both rising and falling edge switching thresholds for the particular teeth, phase error (e.g., caused by eccentrically-mounted target wheels) can be more accurately compensated. In this example, the difference in maxima between the rising and falling edges of the tooth T2 may be caused by the target wheel 104 being eccentrically mounted.

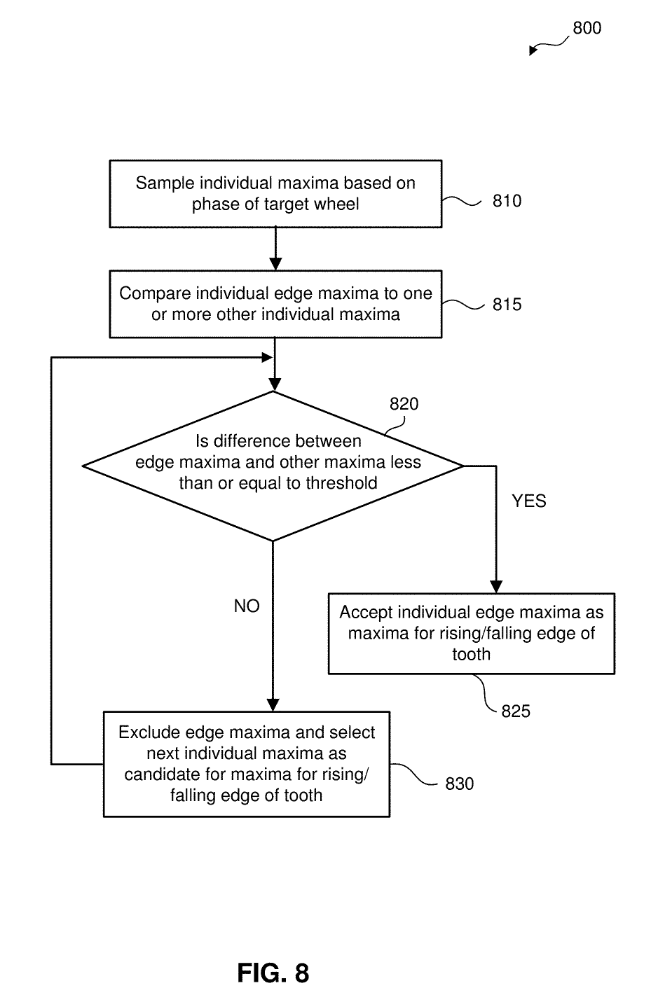

Turing to FIG. 8, a flowchart of an individual edge maxima determination method 800 according to an exemplary embodiment of the present disclosure is illustrated.

The method 800 can be used to determine the rising and/or falling edge maximum values for a corresponding tooth 106 of the target wheel 104. The flowchart is described with continued reference to FIGS. 1-7. The operations of the method are not limited to the order described below, and the various operations may be performed in a different order. Further, two or more operations of the method may be performed simultaneously with each other.

The method 800 begins at operation 810, where individual maxima values are sampled (e.g., samples 735 and 755) based on the phase of the target wheel (e.g., based on the sampling signal of the phase sampler 530. In an exemplary embodiment, the individual edge maxima circuit 520 samples the individual maxima values.

After operation 810, the method 800 transitions to operation 815, where two or more of the samples are compared to with each other. In an exemplary embodiment, the individual edge threshold circuit 535 is configured to compare two or more of the samples (e.g., 735) from the individual edge maxima circuit 520 with each other to determine if one or more samples of the maximum samples 735 is a valid maximum value, or if the sample should be discarded. For example, the individual edge threshold circuit 535 can compare the sample 720 with one or more of the samples 725 (and possibly sample 730).

At operation 820, if the difference between the samples is less than or equal to a threshold value (YES at 820), method 800 transitions to operation 825, where the sample is accepted (e.g., considered valid and not an outlier sample) as the individual edge maximum value for the corresponding rising/falling edge of the tooth.

If the difference between the samples is above the threshold (NO at 820), the sample is excluded. The next sampled individual maxima is selected as a candidate for the individual edge maxima for the tooth. The method 800 then returns to operation 820 and is repeated.

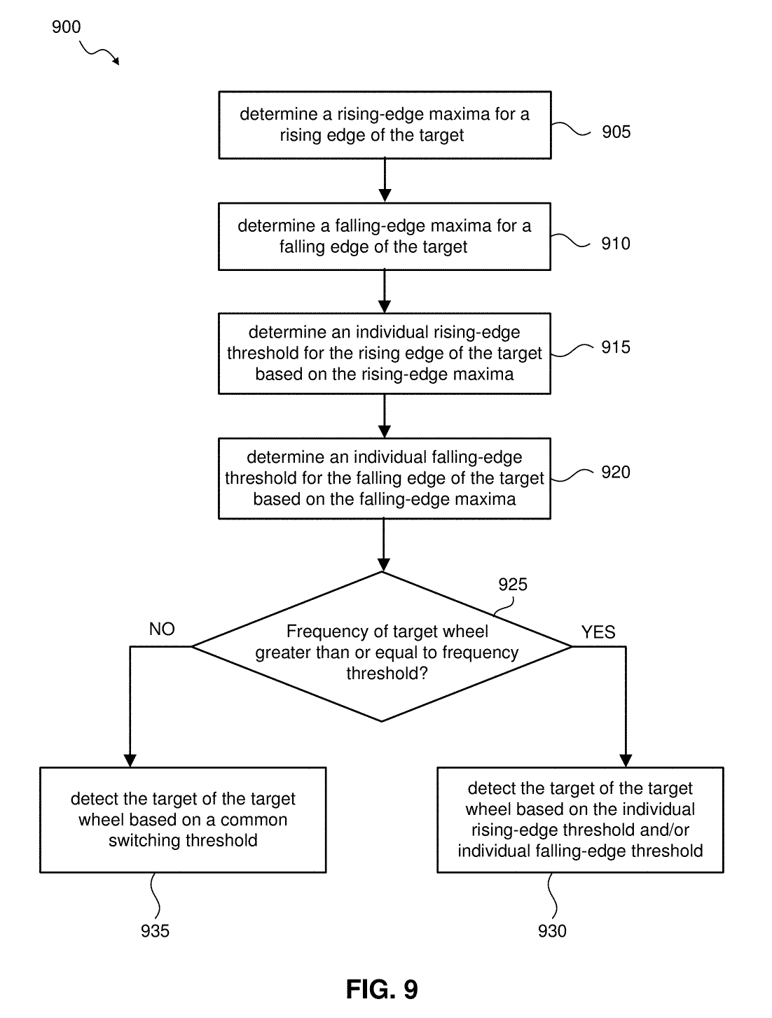

Turing to FIG. 9, a flowchart of target determination method 900 according to an exemplary embodiment of the present disclosure is illustrated.

The method 900 can be used to detect a target 106 of the target wheel 104 based on one or more switching thresholds. The flowchart is described with continued reference to FIGS. 1-8. The operations of the method are not limited to the order described below, and the various operations may be performed in a different order. Further, two or more operations of the method may be performed simultaneously with each other.

The method 900 begins at operation 905, where a rising-edge maxima for a rising edge of the target is determined. For example, the individual edge maxima circuit 520 can be configured to determine the rising-edge maxima for a rising edge of the target.

After operation 905, the method 900 transitions to operation 910, where a falling-edge maxima for a falling edge of the target is determined. For example, the individual edge maxima circuit 520 can be configured to determine the falling-edge maxima.

After operation 910, the method 900 transitions to operation 915, where an individual rising-edge threshold for the rising edge of the target is determined based on the rising-edge maxima. For example, the individual edge threshold circuit 535 can be configured to determine the individual rising-edge threshold.

After operation 915, the method 900 transitions to operation 920, where an individual falling-edge threshold for the falling edge of the target is determined based on the falling-edge maxima. For example, the individual edge threshold circuit 535 can be configured to determine the individual falling-edge threshold.

After operation 920, the method 900 transitions to operation 925, where the frequency of the target wheel is compared to a frequency threshold. If the frequency of the target wheel is greater than or equal to the frequency threshold (YES at 925), the method 900 transitions to operation 930. If the frequency of the target wheel is less than the frequency threshold (NO at 925), the method 900 transitions to operation 935.

At operation 930, the target of the target wheel is detected based on the individual rising-edge threshold and/or individual falling-edge threshold.

At operation 935, the target of the target wheel is detected based on a common switching threshold.

### CONCLUSION

The aforementioned description of the specific embodiments will so fully reveal the general nature of the disclosure that others can, by applying knowledge within the skill of the art, readily modify and/or adapt for various applications such specific embodiments, without undue experimentation, and without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The exemplary embodiments described herein are provided for illustrative purposes, and are not limiting. Other exemplary embodiments are possible, and modifications may be made to the exemplary embodiments. Therefore, the specification is not meant to limit the disclosure. Rather, the scope of the disclosure is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer.

For the purposes of this discussion, the term “processor circuitry” shall be understood to be circuit(s), processor(s), logic, or a combination thereof. For example, a circuit can include an analog circuit, a digital circuit, state machine logic, other structural electronic hardware, or a combination thereof. A processor can include a microprocessor, a digital signal processor (DSP), or other hardware processor. The processor can be “hard-coded” with instructions to perform corresponding function(s) according to embodiments described herein. Alternatively, the processor can access an internal and/or external memory to retrieve instructions stored in the memory, which when executed by the processor, perform the corresponding function(s) associated with the processor, and/or one or more functions and/or operations related to the operation of a component having the processor included therein.

In one or more of the exemplary embodiments described herein, processor circuitry can include memory that stores data and/or instructions. The memory can be any well-known volatile and/or non-volatile memory, including, for example, read-only memory (ROM), random access memory (RAM), flash memory, a magnetic storage media, an optical disc, erasable programmable read only memory (EPROM), and programmable read only memory (PROM). The memory can be non-removable, removable, or a combination of both.

1. A sensor system for sensing a target wheel having a plurality of targets, the sensor system comprising:
a sensor configured to sense rotation of the target wheel and generate an output signal corresponding to the sensed rotation; and
sensor circuitry configured to:
compare a frequency of the target wheel to a frequency threshold;
select a switching threshold, based on the comparison of the frequency of the target wheel to the frequency threshold, from one of: a first threshold and a second threshold; and
detect at least one of the plurality of targets of the target wheel based on the output signal of the sensor and the switching threshold.

2. The sensor system of claim 1, wherein:
the first threshold is a common switching threshold associated with the plurality of targets of the target wheel, and
the second threshold is a corresponding individual switching threshold for a respective one of the plurality of targets of the target wheel.

3. The sensor system of claim 1, wherein the sensor circuitry is further configured to identify individual targets of the plurality of targets of the target wheel.

4. The sensor system of claim 3, wherein the sensor circuitry is configured to detect the at least one of the plurality of targets based on the output signal, an identification of the at least one of the plurality of targets, and the second threshold.

5. The sensor system of claim 4, wherein the sensor circuitry comprises a tooth counter that is configured to count the individual targets of the plurality of targets to identify the individual targets of the plurality of targets.

6. The sensor system of claim 4, wherein the sensor circuitry comprises a phase estimator that is configured to estimate a phase of the target wheel to identify the individual targets of the plurality of targets.

7. The sensor system of claim 2, wherein the corresponding individual switching threshold comprises:
a rising-edge threshold for a rising edge of the respective one of the plurality of targets of the target wheel; and
a falling-edge threshold for a falling edge of the respective one of the plurality of targets of the target wheel.

8. The sensor system of claim 1, wherein the sensor circuitry is further configured to:
determine the first threshold based on an average maximum of the plurality of targets of the target wheel; and
determine the second threshold based on a corresponding individual maximum for a respective one of the plurality of targets of the target wheel.

9. The sensor system of claim 8, wherein the sensor circuitry is further configured to:
determine a common minimum of the plurality of targets of the target wheel; and
determine the first threshold based on the average maximum and the common minimum.

10. The sensor system of claim 8, wherein the corresponding individual maximum comprises:
a rising-edge maximum for a rising edge of the respective one of the plurality of targets of the target wheel; and
a falling-edge maximum for a falling edge of the respective one of the plurality of targets of the target wheel.

11. The sensor system of claim 10, wherein the sensor circuitry is further configured to:
determine a plurality of maximum samples of the respective one of the plurality of targets of the target wheel; and
determine the rising-edge maximum based a first comparison between maximum samples of the plurality of maximum samples; and
determine the falling-edge maximum based a second comparison between the maximum samples of the plurality of maximum samples.

12. A sensor system for sensing a target wheel having a plurality of targets, the sensor system comprising:
a sensor configured to sense rotation of the target wheel and generate an output signal corresponding to the sensed rotation; and
sensor circuitry configured to:
compare a frequency of the target wheel to a frequency threshold;
determine an individual rising-edge threshold for a rising edge of at least one target of the plurality of targets of the target wheel;
determine an individual falling-edge threshold for a corresponding falling edge of the at least one target;
determine a common switching threshold associated with the plurality of targets of the target wheel;
detect the at least one target of the plurality of targets of the target wheel based on the output signal of the sensor and one of:
at least one of the individual rising-edge threshold and the individual falling-edge threshold, in a first mode of operation, and
the common switching threshold, in a second mode of operation,
wherein the first and the second modes of operation are based on the comparison of the frequency of the target wheel to the frequency threshold.

13. The sensor system of claim 12, wherein the sensor circuitry is further configured to switch between the first mode of operation and the second mode of operation based on a frequency of the target wheel.

14. The sensor system of claim 12, wherein the sensor circuitry is further configured to:
identify individual targets of the plurality of targets of the target wheel; and
detect the at least one of the plurality of targets based on the output signal, an identification of the at least one of the plurality of targets, and at least one of the individual rising-edge threshold and the individual falling-edge threshold.

15. The sensor system of claim 14, wherein the sensor circuitry comprises:
a tooth counter that is configured to count the individual targets of the plurality of targets to identify the individual targets of the plurality of targets; or
a phase estimator that is configured to estimate a phase of the target wheel to identify the individual targets of the plurality of targets.

16. The sensor system of claim 12, wherein the sensor circuitry is configured to determine the individual rising-edge threshold of the rising edge of the at least one target based on the individual falling-edge threshold for the falling edge of the at least one target and an individual falling-edge threshold for a falling edge of a previous target of the plurality of targets of the target wheel.

17. The sensor system of claim 16, wherein the sensor circuitry is configured to interpolate between the individual falling-edge threshold for the falling edge of the at least one target and the individual falling-edge threshold for the falling edge of the previous target of the plurality of targets.

18. A sensor system for sensing a target wheel having a plurality of targets, the sensor system comprising:
a sensor configured to sense rotation of the target wheel; and
sensor circuitry configured to:
determine a rotational speed of the target wheel based on the sensed rotation;
determine an average maximum of the plurality of targets of the target wheel;
determine a rising-edge maximum for a rising edge of the at least one target of the plurality of targets of the target wheel;
determine a falling-edge maximum for a corresponding falling edge of the at least one target;
detect the at least one target of the plurality of targets of the target wheel based on a section from one of:
(a) the average maximum, and
(b) the rising-edge maximum and the falling-edge maximum,
wherein the selection is based on the rotational speed of the target wheel.

19. The sensor system of claim 18, wherein the sensor circuitry is further configured to:
determine an individual rising-edge threshold for the rising edge of the at least one target and an individual falling-edge threshold for the falling edge of the at least one target based on the rising-edge maximum and the falling-edge maximum, respectively,
wherein the detection of the at least one target is based on the output signal of the sensor and the individual rising-edge threshold and the individual falling-edge threshold.

20. The sensor system of claim 18, wherein the sensor circuitry is further configured to:
determine a plurality of maximum samples of the at least one target of the plurality of targets of the target wheel; and
determine the rising-edge maximum based a first comparison between maximum samples of the plurality of maximum samples; and
determine the falling-edge maximum based a second comparison between the maximum samples of the plurality of maximum samples.
